(19) United States
(12) Patent Application Publication
(10) Pub. No.: US 2022/0349824 A1
(43) Pub. Date: Nov. 3, 2022

(54) Automated Organism Sorting Device and Method of Use

(71) Applicant: GENETIRATE, INC., Tucson, AZ (US)

(72) Inventors: Benjamin Renquist, Tucson, AZ (US); Kyle Kentch, Tucson, AZ (US)

(73) Assignee: GENETIRATE, INC., Tucson, AZ (US)

(21) Appl. No.: 17/764,429

(22) PCT Filed: Oct. 3, 2020
(86) PCT No.: PCT/US2020/054181

§ 371 Date: Mar. 28, 2022

Related U.S. Application Data
(60) Provisional application No. 62/910,898, filed on Oct. 4, 2019.

(51) Int. Cl. G01N 21/64; G01N 21/27

(52) U.S. Cl. CPC G01N 21/6452; G01N 21/274; G01N 2021/6439

(57) ABSTRACT

The present invention provides a system, an apparatus, and a method of sorting organisms. More particularly the invention provides a system utilizing fluorescence for determining growth potential of an organism through optics unit measurements and data processing application. This invention provides a system by which fluorescence can be measured to sort based on sex or expression of a given gene.

### CROSS-REFERENCE TO RELATED APPLICATIONS

This Application is a U.S. national stage filing under Section 371 of International Application No. PCT/US2020/054181, filed on Oct. 3, 2020, which claims benefit of and priority to U.S. Provisional Patent Application No. 62/910,898 filed Oct. 4, 2019, the contents of each are incorporated by reference in their entireties.

### FIELD OF THE DISCLOSURE

The present invention relates to an organism sorting apparatus, system and method. More specifically, to an apparatus that can sort organisms such as fish embryos according to growth potential using a fluorescence.

### BACKGROUND OF THE INVENTION

Sorting of organisms based on certain characteristics (e.g., live or dead, pin-eyed, etc.) is a well-known practice in the Industry. Over the years, several apparatuses and machines have also been developed to carry out the sorting process. However, to undertake an exercise of sorting a large volume of such organisms is an enormously difficult task. Even the existing apparatuses use limited technology to ascertain characteristics accurately and efficiently.

Some apparatuses include rotary discs with holes to isolate organism samples such as fish eggs so that fish eggs are isolated one at a time into each hole allowing the user to measure a given parameter and remove bad eggs. There are other apparatuses that have a disc formed with a plurality of holes having a dimension capable of accommodating only one fish egg that is rotated in water in which fish eggs are floating. However, the existing apparatuses have significant limitations in the sensing capabilities of the apparatuses that limit sorting to visually evident measures of egg quality.

Moreover, the conventional apparatuses do not have a precise determination of the potential growth of the eggs. Most of the existing apparatuses only determine if the organism is alive or dead. Some apparatuses determine the dimensions of an organism to sort them. They do not sort the organisms based on precise growth potential. The technology required to ascertain these characteristics efficiently has not been implemented and hence the sorting for better growth is not possible with existing apparatuses. In view of the above, there remains a continuing need for an improved system, apparatus and method of sorting organisms. Moreover, there is a need of systems and method that can be implemented on existing sorters to improve the sorting process.

### BRIEF SUMMARY OF THE PRESENT INVENTION

Accordingly, various embodiments of the present invention are generally related to automated sorting to segregate individual organisms, and in particular aquatic organisms, based on a fluorescent signal. Embodiments in the present invention build on technology disclosed in U.S. patent application Ser. No. 15/754,126, entitled, “Methods and Systems for Measuring Growth Rate in Plant or Aquatic Animal Species,” to Renquist et al., the contents of which are incorporated by reference in its entirety. In an embodiment, the present invention provides a sample sorting system. The system includes an optics unit configured for generating and projecting an excitation light beam on one or more samples, a photodetector for receiving through the optics unit an emission light generated by a sample of the one or more samples, and converting an intensity of the emission light into an electric signal and transferring the electric signal to a control unit, and a computing device having a data processing application configured for processing the electric signal received from the control unit to sort the sample in one or more groups based on fluorescence wherein the computing device sends a sample sorting data to the control unit for enabling the control unit to collect the sample according to the groups.

In one embodiment the invention provides a sample sorting apparatus. The apparatus includes a rotating disc having a plurality of wells on perimeter of the disc for receiving a sample each, a feeder configured for loading the samples onto the wells of the disc, an optics unit configured for generating and projecting an excitation light beam onto the sample, a photodetector for receiving through the optics unit an emission light generated by the sample and converting an intensity of the emission light into an electric signal transferring the electric signal to a control unit, a computing device having a data processing application configured for processing the signal received from the control unit to sort the samples in one or more groups based on fluorescence wherein the computing device sends a sample sorting data to the control unit for enabling the control unit to execute a collection of the samples according to the groups in respective group containers, and a plurality of air or water valves connected to a relay each wherein the control unit triggers the relays for enabling the air or water valves to open according to the sample sorting data thereby enabling the air or water valves to push the samples into the respective group containers through a plurality of channels.

In an embodiment, the present invention provides a sample sorting method. The method includes the steps of loading a plurality of samples onto a rotating disc wherein the rotating disc includes a plurality of wells on perimeter of the disc for receiving a sample each, generating an excitation light beam by an optics unit and projecting the excitation light beam onto the samples, receiving through the optics unit an emission light generated by the sample and converting an intensity of the emission light into an electric signal and transmitting the electric signal to a control unit, and processing the signal received from the data control unit by a data processing application of a computing device to sort the samples in one or more groups based on fluorescence wherein the computing device sends a sample sorting data to the control unit thereby enabling the control unit to execute a collection of the samples according to the groups in respective group containers, wherein the control unit triggers one or more relays for enabling air or water valves corresponding to the triggered relay to open according to the sample sorting data thereby enabling the air or water valves to push the samples into respective group containers through a plurality of channels.

In an embodiment, the present invention provides a computer program product for sample sorting. The product includes a computer readable storage medium readable by a processor and storing instructions for execution by the processor for performing a sorting method, the method comprising, initiating a calibration operation on a representative subset of the samples to be sorted into groups based on required group characteristics, determining an average fluorescence value for each sample within the subset of the samples by a peak detection and averaging algorithm, ranking the determined fluorescence values and separating the samples into the groups, determining a fluorescence threshold value at boundaries between each group, such that the fluorescence threshold value falls between a highest sample value of a group having weaker fluorescence, and a lowest sample value of a group having stronger fluorescence, initiating a sample sorting operation for sorting the samples into groups, in response to detection of a peak in one or more samples, comparing the average fluorescence value of the one or more samples to group fluorescence threshold values determined by the calibration operation, and sorting the one or more samples into respective groups and sending the sample sorting data to a control unit for enabling the control unit to trigger collection of the sample according to the groups.

In an embodiment, the present invention predicts the growth potential of a sample organism using the fluorescence detection in the sample when the sample undergoes a redox reaction. The sample is subject to a redox indicator such as resazurin which triggers a change in color indicating the reaction of the redox indicator by NADH. When a sample organism like a fish embryo or other aquatic organism consumes more oxygen, it correlates with higher growth. Oxygen consumption is an effective standard in measuring metabolic rate in an organism, so instead of measuring oxygen consumption directly, the invention identifies the color/fluorescence shift to predict growth potential of the fish early on in the stage of just the embryo. The system, apparatus and method of the present invention sorts all sample organism such as eggs into high potential growth, and low potential growth based on fluorescent detection of the redox reaction. Other redox indicators may work as well without detracting from the spirit of the invention, such as tetrazolium dies.

In an advantageous aspect, the present invention increases the throughput of a metabolic rate assay to predict growth and feed efficiency of organisms. The technology may also be applied to sort based on gene expression or gender, as well as other traits, if applied to select based on gender in fish genetically modified to carry fluorescent tags on the X or Y chromosome or gene expression in fish with promotor driven GFP expression. The present invention is especially useful when applied to aquatic farm species. Further, the present invention can be implemented on existing sorters to improve the sorting processes, thereby reducing the cost of creating a completely new structure for the sorter.

### BRIEF DESCRIPTION OF THE DRAWINGS

FIG. 1 is a front view of a sample sorting system in accordance with an embodiment of the invention;

FIG. 2 is a perspective side view of a sorting apparatus in accordance with an embodiment of the invention;

FIG. 3 is a perspective view of the sorting apparatus showing the sorting apparatus with an optics unit and an electronics unit in accordance with an embodiment of the invention;

FIG. 4 is a perspective view of the sorting apparatus showing the control unit and the optics unit in accordance with an embodiment of the invention;

FIG. 5 is a perspective view of the sorting apparatus showing a plurality of air or water valves placed behind a rotating disc for blowing air or water in wells of the disc to remove a sample in accordance with an embodiment of the invention;

FIG. 6 is a top view of the sorting apparatus showing a plurality of channels for moving the sorted eggs into the respective containers in accordance with an embodiment of the invention;

FIG. 7 is a front view of a rotating disc with a guard in accordance with an embodiment of the invention;

FIG. 8 is a perspective view of the optics unit in accordance with an embodiment of the invention;

FIG. 9 is a top view of the optics unit of the sorting apparatus in accordance with an embodiment of the invention;

FIG. 10 is a perspective view of an electronics unit of the sorting apparatus in accordance with an embodiment of the invention;

FIG. 11 is a perspective side view of the electronics unit with a speed controller and a beam breaker in accordance with an embodiment of the invention.

FIG. 12 is a flowchart depicting a sample sorting method by a data processing application in accordance with an embodiment of the invention.

### DETAILED DESCRIPTION OF EMBODIMENTS

The invention now will be described more fully hereinafter with reference to the accompanying drawings, in which embodiments of the invention are shown. This invention may however be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section.

It will be understood that the elements, components, regions, layers and sections depicted in the figures are not necessarily drawn to scale.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” “upper” or “top,” “left” or “right,” “above” or “below,” “front” or “rear,” may be used herein to describe one element's relationship to another element as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. Values of certain variables may be approximations and may also be ±5%, 10%, 25%, 50% or more, without detracting from the spirit of the invention. The invention illustratively disclosed herein suitably may be practiced in the absence of any elements that are not specifically disclosed herein.

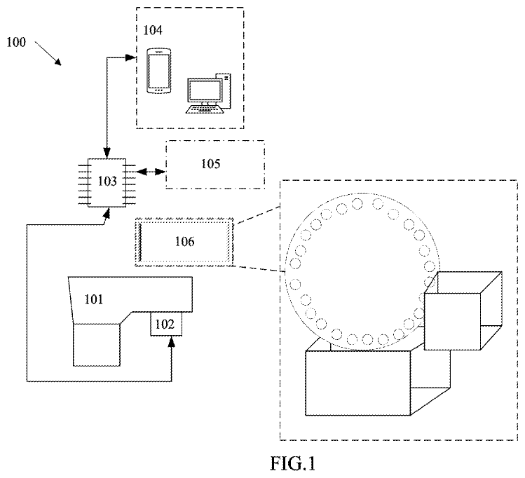

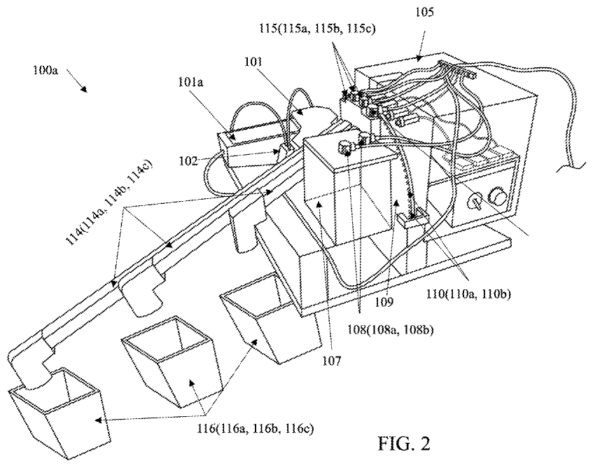

Referring to FIG. 1, a sample sorting system 100 is shown in accordance with an embodiment of the invention. The system 100 includes an optics unit 101 for generating and projecting an excitation light beam (which may be, but not required to be, a collimated light beam) on one or more samples. The excitation light beam is generated by a laser source 101a (shown in FIG. 2). The system 100 further includes a photodetector 102 for receiving through the optics unit an emission light (which may be fluorescence light) emitted by the sample. The intensity of the transmitted light is converted to an electric signal (such as voltage) and transmitted to a control unit 103. The system also includes a computing device 104 having a data processing application configured for processing the signal from the control unit 103 to sort the sample in one or more groups based on fluorescence. The computing device 104 sends sample sorting data to the control unit 103 for enabling the control unit to sort the sample according to the groups. The control unit 103 is communicatively coupled to the photodetector 102, the computing device 104 and an electronics unit 105. The electronics unit 105 receives a trigger signal from the control unit 103 for operating one or more components of the electronics unit 105 to collect the sample according to the sorted group. The system 100 includes a sample detection and collection (SDC) unit 106 which is configured to detect the characteristics of a sample when subject to the excitation light beam from the optic unit. Further, the SDC unit 106 includes means to move the sample across the unit and collect it in containers as per sorted groups.

In an embodiment, the optics unit 101 is configured to project an excitation light beam on the samples to capture redox reaction inside the sample based on fluorescence. The excitation light beam falling on the sample initiates emission of an emission light (e.g. fluorescence light) from the sample which is captured by the optics unit 101 and a fluorescence light signal is detected through the photodetector 102. The control unit 103 receives the sample sorting data from the computing device 104 for generating the trigger signal for the electronics unit 105 to initiate a sorting operation through SDC unit 106 for collecting the samples according to the one or more groups.

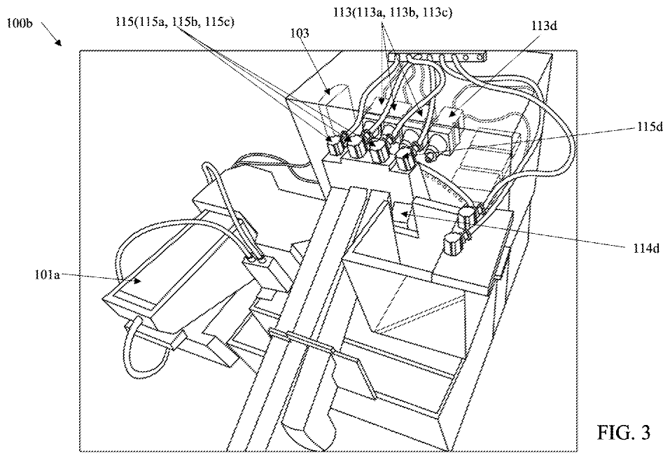

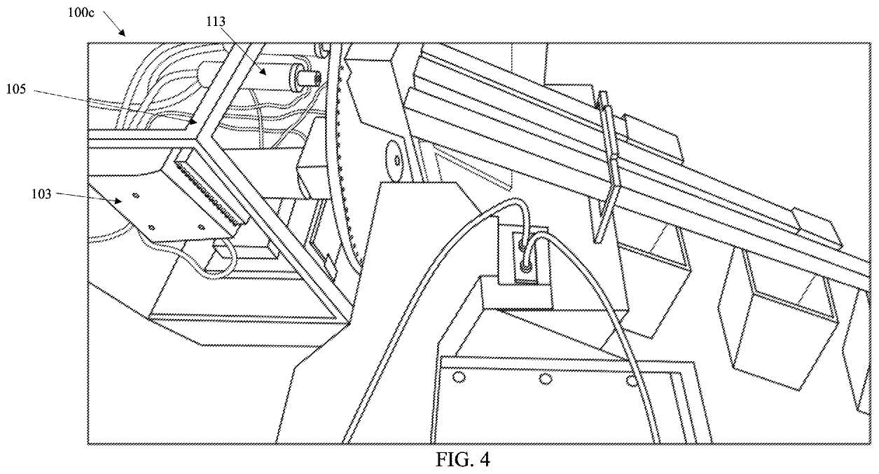

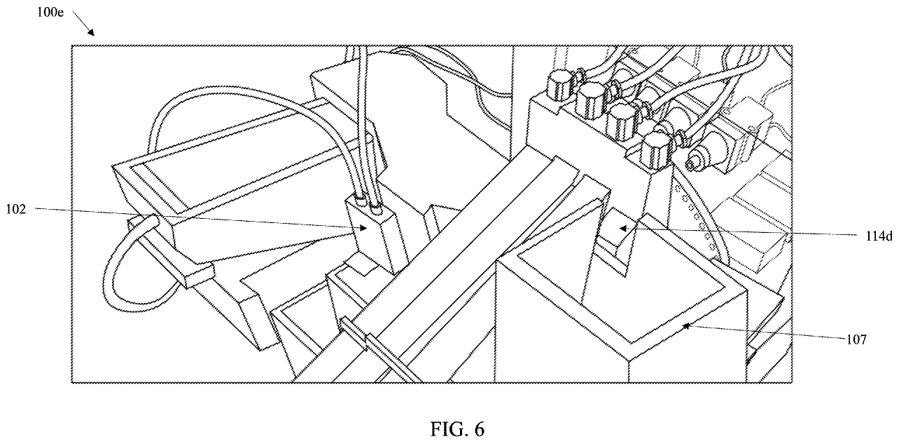

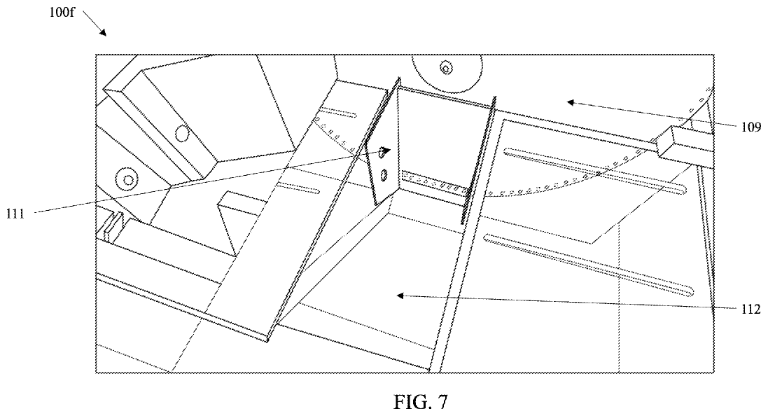

Referring to FIG. 2-FIG. 7, different views (100a, 100b, 100c, 100d, 100e, 100f) of various components/elements of an egg sample sorting apparatus are provided in accordance with example embodiments of the invention. The apparatus includes a feeder 107 to load the eggs onto the apparatus 100a, one or more feeder water valves 108 (108a, 108b) spraying water inside the feeder 107 for allowing the eggs to move towards a rotating disc 109. The feeder 107 includes a downward ramp structure allowing the sample eggs to flow towards the disc 109. The rotating disc 109 includes a plurality of wells 110 (110a, 110b) on the perimeter of the disc 109 for retaining the eggs flowing from the feeder 107. The apparatus 100a includes a guard 111 for controlling the flow of eggs from the feeder 107 through a ramp container section 112 towards the rotating disc 109 thereby preventing overflow of the eggs. The feeder 107 includes the ramp container section 112 below the feeder that receives the eggs fed from the feeder 107 and loads the eggs onto the wells 110 of the disc 109. The adjustable guard 111 rests on the ramp container section 112 and prevents the eggs from falling out. The optic unit (or optic box) 101 generates a collimated light beam having a preferred wavelength of 530 nm, and as the eggs that are loaded inside the wells 110 of the rotating disc 109 passes the collimated light beam, it excites the resazurin in the eggs and that emits 590 nm wavelength light from the eggs. The emitted light passes through the optics unit 101 and it is detected by the photodetector 102. The photodetector 102 sends a signal to the control unit/data acquisition unit (DAU) 103. The control unit 103 reads the emission/fluorescence signal and provides the data to the computing device 104. The computing device 104 includes the data processing application for sorting the eggs based on the emission/fluorescence data provided by the control unit 103. The computing device 104 sends a signal to control unit 103 to trigger firing of a plurality of air or water valves 113 (113a, 113b, 113c) that are pointed at the rotating disc 109. Each air or water valve 113 is pointed at the wells 110 of the rotating disc 109 and a channel 114 (114a, 114b, 114c) each corresponding to each of the air or water valves 113 is configured to receive and move the eggs. Depending on the information in the signal about the groups in which the eggs are to be sorted, the air or water valves 113 (113a, 113b, 113c) puff air or water to push the egg into the respective channel 114 (114a, 114b, 114c). The apparatus includes a channel water source 115 (115a, 115b, 115c) above each channel 114 (114a, 114b, 114c), where the water source 115 pushes the eggs down each of the channels 114 to be collected in respective containers 116 (116a, 116b, 116c).

In an exemplary embodiment, the apparatus 100a includes a calibration mechanism where the apparatus 100a pushes the initial eggs into a calibration channel 114d connected to the feeder 107. The control unit 103 triggers a calibration air or water valve 113d to puff/blow air or water into the wells 110 of the disc 109 from behind. The air or water pushes the eggs into the calibration channel 114d. The apparatus 100a includes a calibration water source 115d above the calibration channel 114d for pushing the eggs back into the feeder 107 and those eggs are sorted later. After initial calibration, the calibration water valve 115d may be closed.

In an embodiment, the control unit 103 includes a processor that may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user and convert them for submission to the processor. In addition, an external interface may be provided in communication with the processor, so as to enable near area communication of device with other devices. The external interface may provide, for example, for wired communication in some implementations, or wireless communication in other implementations, and multiple interfaces may also be used.

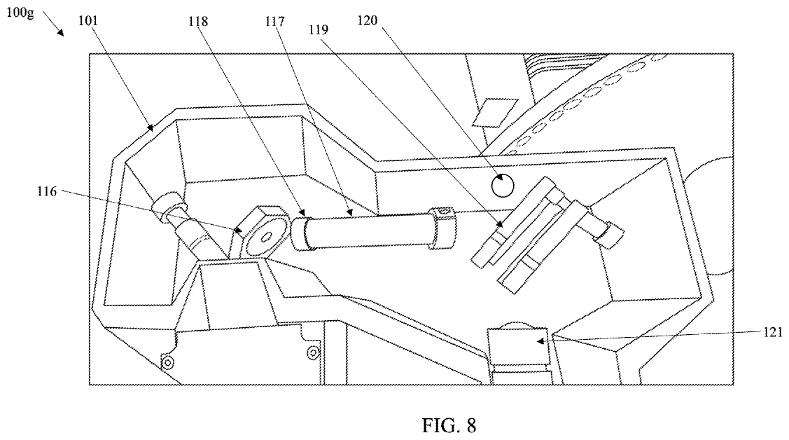

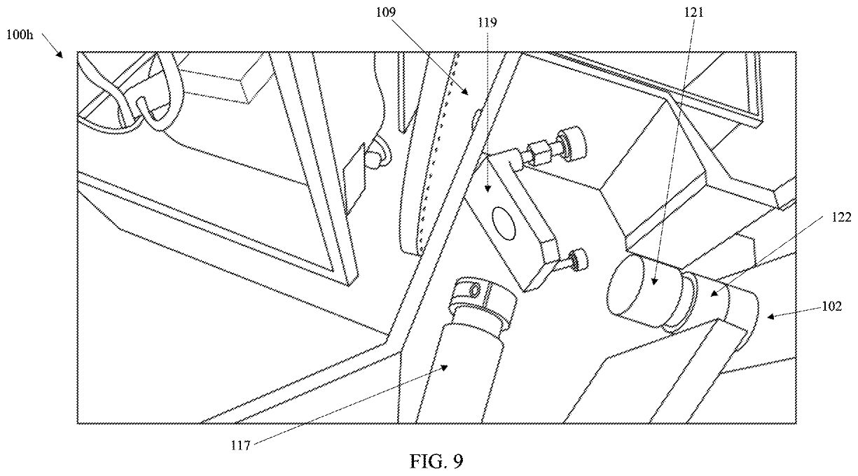

FIG. 8 and FIG. 9, shows a top view (100g) and a perspective view (100h) of the optic unit 101 in accordance with an embodiment of the invention. The optic unit 101 includes a first mirror 128 (which may be a silver mirror) configured for receiving a excitation/collimated light beam from the laser source 101a. The laser source 101a is an adjustable-power 500 mW, 532 nm CW laser module (Opto Engine LLC, MGL-FN-532) that is directed at the mirror 128 (Thorlabs, PF10-03-P01). The laser source goes up to 500 mW. The optic unit 101 further includes a telescopic arrangement of lenses 117 configured to receive the light beam deflected from the mirror 128 and widen the beam before focusing. The telescopic arrangement 117 includes an iris diaphragm 118 for adjusting the diameter of the beam deflected from the mirror 128. The telescopic arrangement 117 may include a lens tube (Thorlabs, SM05V10), which contains a −50.0 mm focal length NBK-7 coated bi-concave lens (Thorlabs, LD1357), a 100.0 mm focal length NBK-7 coated Plano-convex lens (Thorlabs, LA1207), and a 20.0 mm focal length NBK-7 A coated Plano-convex lens (Thorlabs, LA1074-A). The optics unit 101 includes a 567 nm cut-on wavelength second mirror 119 (Thorlabs, DMLP567) (which may be a dichroic mirror) configured to receive the excitation/collimated beam focused on the dichroic mirror 119 by the telescopic arrangement 117 and deflecting the beam to a first lens 120. The first lens 120 re-collimates the beam received from the second mirror 119 before projecting it on the samples of disc 109 so that the beam passing through the sample is a collimated beam. The first lens 120 projects the excitation/collimated beam onto the surface of samples as they pass through a sample reading area. The optics unit includes a silver painted dome at the external surface of the unit near the first lens 120. The dome enables increased collection of the emitted fluorescent signal from the samples. The telescopic arrangement 117 and first lens 120 ensure the beam diameter is slightly smaller than the diameter of the smallest sample to be measured. As the 532 nm light reaches the sample (or approximately 532 nm), the reduced form of resazurin fluoresces, emitting light with a wavelength near 590 nm. Unit 101 includes a focusing lens arrangement 121 configured to receive an emission light (e.g., fluorescent light) emitted by the sample to focus the light onto the photodetector 102.

The emission light is collected by the first lens 120 and transmitted through the dichroic mirror 119 before passing on to the focusing lens arrangement 121. The optics unit 101 includes a plurality of filters 122 arranged within the focusing lens arrangement 121 for narrowing down the bandwidth of the emission/fluorescent light before the light reaches the photodetector 102. The first set of filter(s) is 550 nm long pass filter(s) (Thorlabs, FELH0550), which transmits light with wavelengths longer than 550 nm. The second set of filter(s) is 600 nm short pass filter(s) (Thorlabs, FESH0600), which transmits light with wavelengths shorter than 600 nm. The focusing lens arrangement 121 may include a lens tube (Thorlabs, SM1L20C), which includes a 30.0 mm focal length NBK-7 coated Plano-convex lens (Thorlabs, LA1805) and a 50.0 mm focal length NBK-7 A coated Plano-convex lens (Thorlabs, LA1131-A) to focus the 550-600 nm filtered fluorescent light onto the active area of a silicon amplified detector (Thorlabs, PDA36A2). The focal length of the lens is located beyond the active area surface in such a way that the entire beam is contained within the boundary of the active area. The photodetector 102 includes a chip for capturing the fluorescent light beam signal and converting the signal into a voltage which is transported via a BNC cable (Thorlabs, 2249-C-48). The cable is coupled to a 50 ohm BNC terminator (Thorlabs, T4119) and then a second pigtailed BNC cable (Jameco Benchpro, CBB-069-R), whose wire leads are attached via screw terminal to the analog port of the control unit 103. The control unit 103 is a USB-driven data acquisition unit (Measurement Computing, USB-1208FS-Plus). This control unit 103 is controlled by a data processing application (such as a LabVIEW software program) running on the computing device 104.

In an example embodiment, components of the optics unit 101 are housed within a 3D-printed box made of PLA+ plastic. The mounts for each component attach directly to the printed box via M4 screws and nuts. The laser 101a is mounted to the 3D-printed box made of PLA+ plastic. The mirror 128 may be mounted in a kinematic mirror mount (Thorlabs, KM100). The dichroic mirror 119 may be mounted in a threaded kinematic mirror mount (Thorlabs, KM100T). The telescopic arrangement 117 may be mounted with a lens mount (Thorlabs, SMR05/M) and a lens tube slip ring (Thorlabs, SM05RC/M). The focusing lens arrangement 121 is directly mounted to the photodetector 102. The photodetector 102 is mounted to a 3D-printed bracket that allows for translational repositioning of the photodetector 102 in three dimensions.

In an embodiment, the optics unit 101 may include a pair of silver mirrors (Thorlabs, PF10-03-P01) for deflecting the emission/fluorescence light emitted from the sample towards the focusing lens arrangement. Both mirrors are mounted in kinematic mirror mounts (Thorlabs, KM100).

Since, the alignment of the optical components in the optics unit 101 is extremely crucial for obtaining accurate results, the alignment is verified before measuring fluorescence from samples.

In an example embodiment, a method for verification of the alignment is provided. All optical components should be mounted, with the silver painted dome of the optics box roughly centered on one of the wells 110 of the disc 109. A series of slots are present in the structure of the apparatus 100a for mounting of the optics box. The two M4 screws extending from the bottom of the optics box fit into the slots in the apparatus 100a and are secured with wing nuts. Turn on the laser 101a to verify that the beam reflects off the mirror 128 and travels through the lens tube of the telescopic arrangement 117 for projecting toward the sample reading area. Use a blank index card to examine the laser beam by placing it in the beam path between optical components. First, place the index card against the opening of the lens tube closest to the mirror 128. Adjust the knobs of the kinematic mount holding the mirror 128 until the dot of light is centered within the lens tube opening. Move the index card to the other end of the lens tube and center the dot of light within the opening, again adjusting the knobs of the kinematic mount holding the mirror 128. Repeat this process until the beam of light is centered simultaneously at both ends of the lens tube. Next, move the index card between the dichroic mirror 119 and the first lens 120. Adjust the knobs of the kinematic mount holding the dichroic mirror 119 until the dot of light is centered on the first lens 120. The laser light should now strike near the well 110 of the disc 109. Adjust the positioning of the optics box 101 so that the laser light is centered within the well 110, and so that the face of the optics box 101 that runs parallel to the face of the disc 109 is 9.0 mm distant from the face of the disc 109. A test sample (preferably the smallest diameter sample that will be measured) containing a fluorescent reagent such as resazurin should now be placed in the well 110 and the disc 109 should be rotated until the laser light is centered on the sample. Adjust the positioning of the lens closest to the dichroic mirror 119 within the telescopic arrangement 117 lens tube until the beam that projects onto the sample is collimated. To check this, unmount the optics box 101 so that the laser light leaving the first lens 120 is unobstructed for a few feet. Place the index card in the beam path right after it leaves the optics box 101 and note the beam diameter. Move the index card away from the optics box 101 along the laser light path and note the beam diameter. If the beam diameter changes, the lens closest to the dichroic mirror 119 within the telescopic arrangement 117 lens tube is positioned incorrectly and should be readjusted. Remount the optics box 101 in its position next to the disc 109 and center the laser light on the sample. Observe how the beam hits the surface of the sample. The beam hitting the surface of the sample should be slightly smaller than the diameter of the sample itself. Fine tuning of the beam diameter is performed by adjusting the aperture size of the iris diaphragm within the telescopic arrangement 117. The focusing lens arrangement 121 lens tube contains a plurality of lenses and filters. To visualize the light as it is projected onto the photodetector 102, the filters must first be removed from the focusing lens arrangement 121. The fluorescent light emitted by the sample should pass through the lens tube and strike near the active area (small square silicon chip) of the photodetector 102. To better view the interior of the detector lens tube, rotate the dust cover to see through the holes in the side of the lens tube. Hold the index card at the open end of the detector lens tube. Center the dot of light within the opening by adjusting the sliding mount holding photodetector 102. Looking through the side of the detector lens tube, center the beam on the active area of the detector by again adjusting the sliding mount holding the photodetector 102. If the diameter of the beam striking the active area of the detector 102 is larger than the active area itself, the convex lenses need to be adjusted. To make the beam diameter smaller, move the lenses away from the detector until it fills 70-80% of the active area. After adjusting the lenses, recheck the beam alignment for the focusing lens arrangement 121. Note the positioning of the lenses and replace the filters into the lens tube, being careful not to jostle any nearby components. Close the dust cover of the lens tube. Close the lid of the optics box and secure with M4 screws. After this, the alignment process is complete. The optics unit 101 should not be moved for the duration of the sample measurement process.

In an exemplary embodiment, the computing device 104 includes the data processing application (LabVIEW Program) that controls the sample sorting operation (FIG. 1). The computing devices 104 referred to as the computer machines, server, processor etc. of the present invention are intended to represent various forms of digital computers, such as laptops, desktops, workstations, personal digital assistants, and other appropriate computers. Computing devices of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

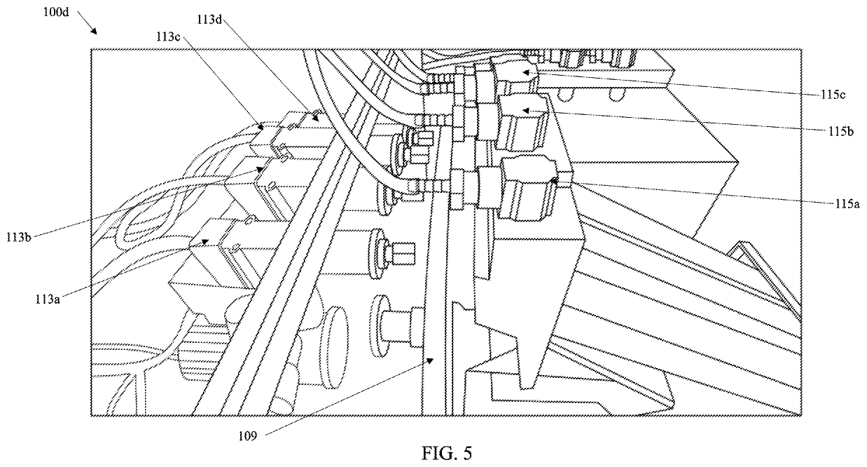

The data processing application drives the control unit/data acquisition unit 103 (MCC, USB-1208FS-Plus), which simultaneously receives analog input from the silicon amplified photodetector 102. The control unit 103 is also configured to communicatively interact with the electronics unit 105 for sending a digital output to the multiple air or water valves 113 (113a, 113b, 113c) (FIG. 5). As the Control unit 103 receives data from the photodetector 102, the LabVIEW program performs real-time peak detection and peak averaging to determine when a sample is detected, and into which group it should be sorted. The data processing application detects a peak (sample) when certain criteria are met: (1) the fluorescence signal must exceed the peak detection threshold; and (2) a complete beam breaker cycle has been detected for exactly one of the wells 110. It is pertinent to note that with smaller sample diameter as well as faster rotation of the disc 109, there will be fewer data points in the fluorescence peak that represents that sample. Once a peak is detected, the average fluorescence value across all data points in the peak is recorded. This is the value that will be used to sort samples into separate groups. For completing the sorting of samples, a few more criteria are required to be fulfilled: (1) the number of groups to be sorted, (2) the size of the groups to be sorted compared to the sample population (i.e. four groups each consisting of 25% of the total population size); and (3) fluorescence threshold values that defines boundaries of each group. The average fluorescence value for each sample is compared against the group threshold values to determine the group in which each sample belongs. It is pertinent to note that the number of groups that can be sorted is physically limited by the number of air or water valves installed on the sample sorting apparatus.

In an exemplary embodiment, since the group threshold values are unknown at the beginning of the sort, the sorter software runs in two different modes: (1) calibration mode; and (2) sorting mode. During calibration mode, peak detection and peak averaging are performed as described above to record the average fluorescence value for each sample within a representative subset of the sample population to be sorted. The average fluorescence values are then ranked from highest to lowest and separated based on the user-defined criteria of group number and group size. A fluorescence threshold value is determined at boundaries between each group, such that the fluorescence threshold value falls between a highest sample value of a group having a weaker fluorescence, and a lowest sample value of a group having a strong fluorescence.

The Sorting mode is used to physically separate the entire sample population into the groups defined during calibration mode. In this mode, peak detection and peak averaging occur as described above. Each time a peak is detected by the software, the average fluorescence value of that sample is compared to the group fluorescence threshold values, and it is digitally sorted into one of the groups. The application triggers the control unit/data acquisition unit 103 to activate the air or water valve 113 corresponding to that group. As the sample moves in front of the air or water valve outlet, a quick puff of air or water launches the sample out of the spinning sample rotor/disc and into the sample collection container 116 containing other samples from the same group (FIG. 2). This process continues until all samples have been sorted into their respective groups. The average fluorescence values and group sorting for each sample are saved to file for further analysis if desired. For smooth operation during sorting mode, the time delay between the moment a sample is detected and the moment the appropriate air or water valve releases a puff of air or stream of water must be fine-tuned. This can be done by placing samples of known average fluorescent values into the sample rotor and adjusting the time delay values within the LabVIEW program until samples are consistently sorted correctly for each group. The length of the puff or air or stream of water can also be adjusted using the software. This value should be large enough that the puff of air or stream of water has enough force to launch the sample out of the sample rotor, but small enough that the puff of air or stream of water is not still active while adjacent samples pass in front of the air or water valve outlet.

In one embodiment, the data processing application includes a peak detection and averaging algorithm. The algorithm includes simultaneously reading emission/fluorescence and beam breaker signals from a control unit and repeating at a defined sampling rate. If the beam breaker signal completes a full cycle for exactly one of the wells 110, the fluorescent signal data points coinciding with that beam breaker cycle may belong to a peak and are analyzed. If the average fluorescence value across all data points in the potential peak is greater than a detection threshold then the data points do belong to a peak that represents one sample and the average fluorescence value is saved and used for calibration and sorting. If the average fluorescence value is less than the detection threshold then, no peak is detected.

In another embodiment, the data processing application includes a group threshold calibration algorithm. The parameters for determining the group threshold are defined by a user. The parameters may include Number of samples required for calibration, Number of groups to be sorted, Size (percentile) of groups to be sorted etc. The apparatus runs peak detection and averaging algorithm to obtain average fluorescence values. Once enough samples have been detected, calibration is performed. The List of sample average fluorescence values are sorted from low to high. The List is split into segments based on size and number of groups to be sorted. Each group's threshold values are determined based on the fluorescence values at the boundaries of each group segment.

In yet another embodiment, the data processing application includes a sorting algorithm. After calibration, each time peak detection and averaging algorithm detects a sample, the sample's average fluorescence value is compared to the group thresholds to determine its group placement. The application through the computing device signals the control unit/data acquisition unit to execute the sorting operation. The control unit connected to the electronics unit activates the required components to physically sort and collect the sample into the appropriate group containers.

In an exemplary embodiment, the user can adjust air or water pulse duration and time delay for each air or water valve to fine tune the physical sorting process.

In an embodiment, the computing device 104 of the invention includes a graphical User Interface for enabling a user to input operating parameters including Detection threshold, Number of groups to sort, Group size (percentile), Number of samples for calibration, Air pulse duration, Time delay for each air or water valve etc. (FIG. 1). Further, the GUI is configured to display numerical outputs including the Total number of eggs sorted, Number of eggs sorted into each group, Group threshold values, other Graphical outputs including Graph of Fluorescence signal over time to visualize sample peaks in real time, Histogram of values used for group threshold calibration, Graph of group threshold values over time etc.

In an embodiment the computing device 104 includes Datafile outputs providing a file containing user input values specific to each sorting operation, File containing data for each detected sample during a sorting operation where the data includes average fluorescence value, Group placement and Group thresholds at the time of sorting.

In an example embodiment, the calibration data, sorting information may be stored for future sorting iterations, in a data store that includes a plurality of databases. The memory data store may be a volatile, a non-volatile memory or memory may also be another form of computer-readable media, such as a magnetic or optical disk. The memory store may also include one or more storage devices capable of providing mass storage. In one implementation, at least one of the storage devices may be or contain a computer-readable medium, such as a floppy disk device, a hard disk device, an optical disk device, a tape device, a flash memory or other similar solid state memory device, or an array of devices, including devices in a storage area network or other configurations.

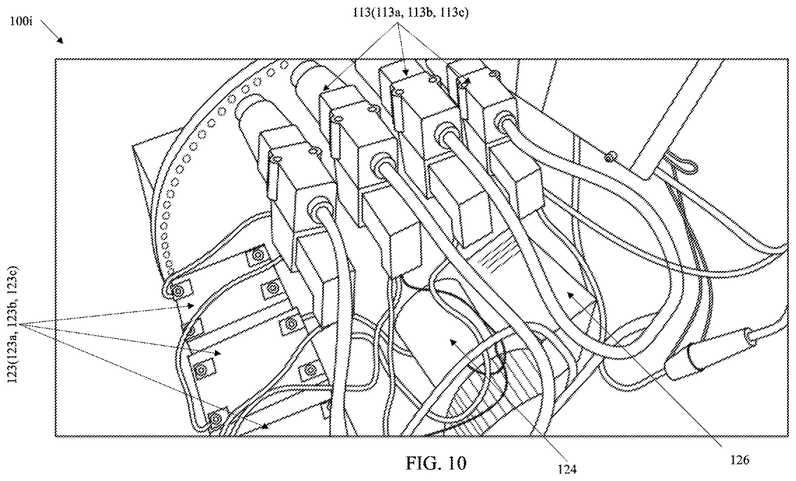

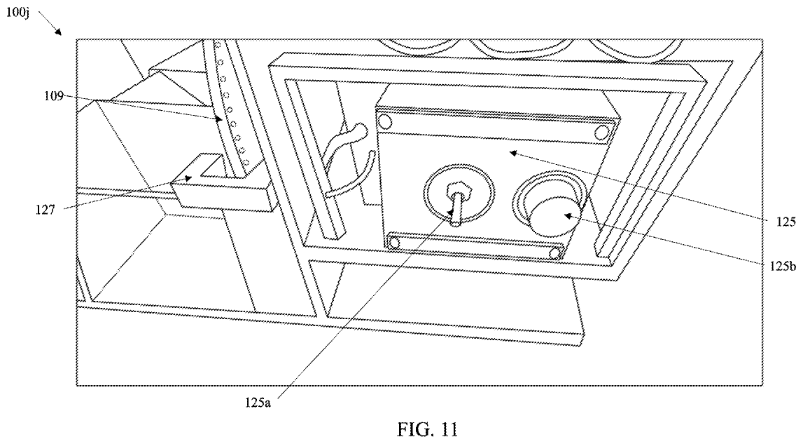

Referring to FIG. 10 and FIG. 11, a perspective view (100i) and side view (100j) of the electronics unit 105 is shown in accordance with an embodiment of the invention. The electronics unit 105 includes a plurality of relays 123 (123a, 123b, 123c) for triggering the one or more of the plurality of air or water valves 113, a motor 124 for rotating the disc 109 connected to a disc speed controller 125, one or more power adapters 126 for powering the relays 123 and the photodetector 102, and a beam break detector 127 having an infrared sensor for detecting wells within the disc. The infrared sensor senses if the beam can pass through the disc and passes that information to the computing device, enabling the computing device to determine timing for sorting organisms. The plurality of relays 123 (123a, 123b, 123c) is connected to the control unit 103 and each of the plurality of air or water valves 113 (113a, 113b, 113c). When a relay is turned ON, it triggers a corresponding air or water valve to open and release air. The air or water valves 113(113a, 113b, 113c) are connected to an air or water source that generates the air or water when the air or water valves open. The electronics unit includes a DC motor for powering the rotating disc and the DC motor is connected to the speed controller 125 configured to control the speed of rotation of the disc 109. The speed controller 125 includes a power ON/OFF switch 125a to start/stop the rotation of the disc 109 and a speed knob 125b to control the speed of rotation of the disc 109.

Exemplary embodiments of the present invention may be a system, a method, and/or a computer program product. The data processing application of the present invention may be incorporated with the computer program product for enabling sorting of the samples. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

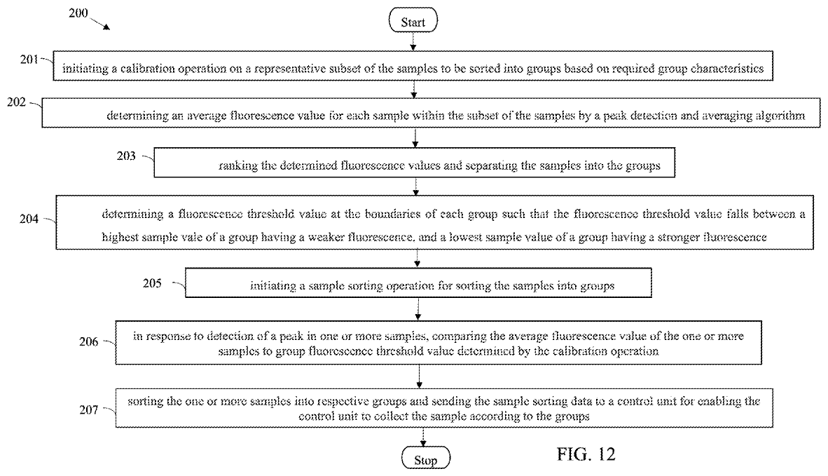

Referring to FIG. 12, a flowchart 200 depicting a method of sample sorting by the data processing application is provided. The method includes step 201, initiating a calibration operation on a representative subset of the samples to be sorted into groups based on required group characteristics. In step 202 determining an average fluorescence value for each sample within the subset of the samples by a peak detection and averaging algorithm. In step 203, ranking the determined fluorescence values and separating the samples into the groups. In step 204, determining a fluorescence threshold value at boundaries between each group, such that the fluorescence threshold value falls between a highest sample value of a group having a weaker fluorescence, and a lowest sample value of a group having a stronger fluorescence. In step 205, initiating a sample sorting operation for sorting the samples into groups and in step 206 in response to detection of a peak in one or more samples, comparing the average fluorescence value of the one or more samples to group fluorescence threshold values determined by the calibration operation. In step 207, sorting the one or more samples into respective groups and sending the sample sorting data to a control unit for enabling the control unit to trigger collection of the sample according to the groups.

The computer readable storage medium can retain and store instructions for use by an instruction execution device, for example, it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

While the invention has been described in terms of exemplary embodiments, it is to be understood that the words that have been used are words of description and not of limitation. As is understood by persons of ordinary skill in the art, a variety of modifications can be made without departing from the scope of the invention defined by the following claims, which should be given their fullest, fair scope.

What is claimed is:

1. A sample sorting system comprising:
an optics unit configured for generating and projecting an excitation light beam on one or more samples;
a photodetector for receiving through the optics unit an emission light generated by a sample of the one or more samples, and converting an intensity of the emission light into an electric signal and transferring the electric signal to a control unit; and,
a computing device having a data processing application configured for processing the electric signal received from the control unit to sort the sample in one or more groups based on fluorescence, wherein the computing device sends a sample sorting data to the control unit for enabling the control unit to collect the sample according to the one or more groups.

2. The system of claim 1, wherein the sample undergoes a redox reaction and changes fluorescence when a redox indicator is added to the sample before subjecting the sample to the excitation light beam, wherein the emission light generated by the sample indicates a fluorescence of the sample after the redox reaction.

3. The system of claim 2, wherein the sample is an embryonic aquatic organism.

4. The system of claim 2, wherein the optics unit includes:
a first mirror configured for receiving the excitation light beam from a laser source;
a telescopic arrangement of lenses configured to receive the excitation light beam deflected from the first mirror and expanding the excitation light beam before focusing;
a second mirror, characterized as being dichroic, configured to receive the excitation light beam focused on the second mirror by the telescopic arrangement and deflecting the excitation light beam to a first lens, wherein the first lens re-collimates the excitation light beam received from the second mirror before projecting it on the samples so that the excitation light beam passing through the sample is a collimated beam;
a focusing lens arrangement configured to receive the emission light generated by the sample and focusing the emission light onto the photodetector, wherein the emission light is received by the first lens and transmitted through the second mirror before passing onto the focusing lens arrangement; and,
a plurality of filters placed within the focusing lens arrangement for narrowing down a bandwidth of the emission light before the emission light reaches the photodetector.

5. The system of claim 4, wherein the electric signal is a voltage signal, and wherein the excitation beam has a wavelength of approximately 532 nm.

6. The system of claim 5, wherein the telescopic arrangement of lenses includes:
an iris diaphragm configured for adjusting a diameter of the exciting light beam deflected from the first mirror.

7. The system of claim 1, further comprising an electronics unit configured to receive the electric signal from the control unit for operating one or more components of the electronics unit to collect the sample according to the one or more groups.

8. A sample sorting apparatus comprising:
a rotating disc having a plurality of wells on perimeter of the rotating disc for receiving a sample each;
a feeder configured for loading the samples onto the wells of the rotating disc;
an optics unit configured for generating and focusing an excitation light beam onto the sample;
a photodetector for receiving through the optics unit an emission light generated by the sample and converting an intensity of the emission light into an electric signal transferring the electric signal to a control unit;
a computing device having a data processing application configured for processing the electric signal received from the control unit to sort the samples in one or more groups based on fluorescence, wherein the computing device sends a sample sorting data to the control unit for enabling the control unit to execute a collection of the samples according to the groups in respective group containers; and,
a plurality of air or water valves each connected to a relay, wherein the control unit triggers the relay for enabling the air or water valves to open according to the sample sorting data, thereby enabling the air or water valves to push the samples into the respective group containers through a plurality of channels.

9. The apparatus of claim 8, further comprising
an electronics unit including a plurality of relays for triggering the air or water valves, a motor for rotating the disc connected to a disc speed controller, at least one power adapter for powering the plurality of relays and the photodetector, and a beam break detector including an infrared sensor for detecting when the sample passes a fluorescent detection area of the optic unit.

10. The apparatus of claim 8, further comprising a guard placed before the rotating disc for controlling flow samples towards the rotating disc.

11. The apparatus of claim 8, further comprising a plurality of water valves for pushing the samples towards the disc.

12. The apparatus of claim 8, wherein the sample undergoes a redox reaction and changes fluorescence when a redox indicator is added to the sample before subjecting the sample to the excitation light beam, wherein the emission light generated by the sample indicates a fluorescence of the sample after the redox reaction.

13. The apparatus of claim 12, wherein the sample an embryonic aquatic organism.

14. The apparatus of claim 8, wherein the optics unit includes:
a first mirror configured for receiving the excitation light beam from a laser source;
a telescopic arrangement of lenses configured to receive the excitation light beam deflected from the first mirror and expanding the excitation light beam before focusing;
a second mirror, characterized as being dichroic, configured to receive the excitation light beam focused on the second mirror by the telescopic arrangement of lenses and deflecting the excitation light beam to a first lens, wherein the first lens re-collimates the excitation light beam received from the second mirror before projecting it on the samples so that the excitation light beam passing through the sample is collimated;
a focusing lens arrangement configured to receive the emission light generated by the sample and focusing the emission light onto the photodetector, wherein the emission light is received by the first lens and transmitted through the second mirror before passing onto the focusing lens arrangement;
a plurality of filters placed within the focusing lens arrangement for narrowing down a bandwidth of the emission before the emission light reaches the photodetector.

15. The apparatus of claim 14, wherein the electric signal is a voltage signal, and wherein the excitation beam has a wavelength of approximately 532 nm.

16. The apparatus of claim 15, wherein the telescopic arrangement of lenses includes:
an iris diaphragm lens configured for adjusting diameter of the excitation light beam deflected from the first mirror.

17. A sample sorting method comprising the steps of:
loading a plurality of samples onto a rotating disc, wherein the rotating disc includes a plurality of wells on perimeter of the rotating disc for receiving a sample each;
generating an excitation light beam by an optics unit and projecting the excitation light beam onto the sample;
receiving through the optics unit an emission light generated by the sample and converting an intensity of the emission light into an electric signal and transmitting the electric signal to a control unit; and,
processing the electric signal received from a data control unit by a data processing application of a computing device to sort the samples in one or more groups based on fluorescence, wherein the computing device sends a sample sorting data to the control unit thereby enabling the control unit to execute a collection of the samples according to the groups in respective group containers,
wherein the control unit triggers one or more relays for enabling air or water valves corresponding to the one or more relays to open according to the sample sorting data thereby enabling the air or water valves to push the samples into respective group containers through a plurality of channels.

18. The method of claim 17, wherein the sample undergoes a redox reaction and changes fluorescence when a redox indicator is added to the sample before subjecting the sample to the excitation light beam, wherein the emission light emitted by the sample indicates a fluorescence of the sample after the redox reaction.

19. The method of claim 18, wherein the redox indicator comprises resazurin, or a tetrazolium dye.

20. The method of claim 18, wherein the sample is an embryonic aquatic organism.

21. The method of claim 18, wherein the step of generating and projecting an excitation light beam through the optics unit includes:
generating the excitation light beam by a laser source and directing the excitation light beam to a first mirror of the optics unit;
receiving the excitation light beam deflected from the first mirror at a telescopic arrangement of lenses and expanding the excitation light beam before focusing; and,
focusing the excitation light beam on a second mirror by the telescopic arrangement of lenses and deflecting the excitation light beam to a first lens, wherein the first lens re-collimates the excitation light beam received from the second mirror before projecting it on the samples so that the excitation light beam passing through the sample is a collimated beam.

22. The method of claim 21 further comprising
receiving the emission light generated by the sample at the first lens and transmitting it through the second mirror;
allowing the emission light to pass the second mirror and receiving the emission light at a focusing lens arrangement; and,
passing the emission light through at least one filter placed within the focusing lens arrangement for narrowing down a bandwidth of the emission light before the emission light reaches a photodetector.

23. The method of claim 22, wherein the electric signal is a voltage signal, and wherein the excitation beam has a wavelength of approximately 532 nm.

24. The method of claim 23 further comprising
adjusting a diameter of the excitation light beam deflected from the first mirror by an iris diaphragm lens of the telescopic arrangement of lenses.

25. The method of claim 1,7 wherein the data processing application is configured to perform rotational calibration to determine a group threshold for each sample group, wherein the rotational calibration includes a list of sample average fluorescence values sorted from low to high and splitting the list into group segments based on size and number of groups to be sorted, wherein the group threshold value for each group is determined based on fluorescence values at the boundaries of each group segment.

26. The method of claim 25, wherein the step of processing the electric signal received from the control unit to sort the samples into one or more groups includes:
comparing each sample's average fluorescence value to the group threshold to determine group placement of the samples.

27. The method of claim 26, wherein the data processing application is configured to compare a sample average fluorescence value to a sample group threshold to determine its group placement, wherein a peak detection and averaging algorithm determines the average fluorescence value on detection of each sample.

28. A computer program product for sample sorting, the product comprising:
a computer readable storage medium readable by a processor and storing instructions for execution by the processor for performing a sorting method, the method comprising:
initiating a calibration operation on a representative subset of the samples to be sorted into groups based on required group characteristics;
determining an average fluorescence value for each sample within the representative subset of the samples by a peak detection and averaging algorithm;
ranking the determined fluorescence values and separating the samples into the groups;
determining a fluorescence threshold value at boundaries between each group, such that the fluorescence threshold value falls between a highest sample value of a group having weaker fluorescence, and a lowest sample value of a group having stronger fluorescence;
initiating a sample sorting operation for sorting the samples into groups;
in response to detection of a peak in one or more samples, comparing the average fluorescence value of the one or more samples to group fluorescence threshold values determined by the calibration operation; and,
sorting the one or more samples into respective groups and sending the sample sorting data to a control unit for enabling the control unit to trigger collection of the sample according to the groups.

29. The computer program product of claim 28, wherein the peak detection and averaging algorithm includes:
reading beam breaker and fluorescence signals from the control unit and repeating at a defined sampling rate:
if beam breaker signal completes full cycle for exactly one well of a rotating disc, all fluorescence signal data points coinciding with beam break cycle belong to a peak that represents one sample if average fluorescence value across those data points>detection threshold, and the average fluorescence value is saved and used for calibration and sorting, else, if the average fluorescence value is less than the detection threshold then, no peak is detected.

30. The computer readable storage medium of claim 28 further storing instructions that cause the processor to automatically add storage for storing sample sorting data.
